(19) United States
(12) Patent Application Publication
(10) Pub. No.: US 2013/0103212 A1
(43) Pub. Date: Apr. 25, 2013

(54) METHOD AND APPARATUS FOR PROVIDING CONTEXT-BASED POWER CONSUMPTION CONTROL

(71) Applicant: Rajasekaran Andiappan, Tampere (FI)

(72) Inventor: Rajasekaran Andiappan, Tampere (FI)

(73) Assignee: NOKIA CORPORATION, Espoo (FI)

(21) Appl. No.: 13/807,727

(22) PCT Filed: Jun. 30, 2010
(86) PCT No.: PCT/IB2010/052997

§ 371 Date: Dec. 29, 2012

(51) Int. Cl. G06F 1/26

(52) U.S. Cl. CPC G06F 1/26
USPC 700/286

(57) ABSTRACT

A method for providing context-based power consumption control may include accessing fused context data. The method may further include determining at least one power consumption control measure for each of a plurality of system layers based at least in part on the fused context data. The method may also include performing multilayered power consumption control by implementing at each respective system layer of the plurality of system layers the at least one power consumption control measure determined for the respective system layer. A corresponding apparatus is also provided.

### TECHNOLOGICAL FIELD

Various implementations relate generally to electronic communication device technology and, more particularly, relate to a method and apparatus for providing context-based power consumption control.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used for execution of a wide range of applications.

The widespread adoption of mobile computing devices and expanding capabilities of the wireless networks over which they communicate has further fueled expansion in the services provided by mobile computing devices. In addition to providing telecommunications services, many mobile computing devices now provide services such as navigation services, camera and video capturing capabilities, digital music and video playback, and web browsing. The ability to provide various services to users of mobile computing devices may be enhanced by tailoring services to particular situations or locations of the mobile terminals. In this regard, various sensors are often incorporated into mobile computing devices. Each sensor typically gathers information relating to a particular aspect of the context of a mobile terminal such as location, speed, orientation, and/or the like. The information from one or more sensors may then be used to determine device context, which may impact the services provided to the user.

While this expansion in services provided by mobile computing devices has been revolutionary, implementation and usage of the services provided by modern mobile computing devices have been somewhat problematic for both developers and users of mobile computing devices. In this regard, these new services provided by mobile computing devices require additional power. In many instances, the additional power consumption required by a service may be quite substantial. This increased power consumption may be quite problematic for battery-powered mobile computing devices. In this regard, while battery life has improved, improvements in battery life have not kept pace with the virtually exponential growth in the capabilities of mobile devices. Accordingly, users of mobile computing devices may be forced to frequently recharge the battery or limit their usage, which may significantly degrade the user experience.

### BRIEF SUMMARY

Methods, apparatuses, and computer program products are herein provided for providing context-based power consumption control. Methods, apparatuses, and computer program products in accordance with various embodiments may provide several advantages to computing devices and computing device users. In this regard, some example embodiments may leverage context data to determine one or more power consumption control measures that may reduce power consumption by a computing device when appropriate given a context of the device and/or a user of the device as indicated by the context data. Such power consumption control measures may accordingly be made without user intervention and may, for example, extend battery life for battery-powered devices. In some example embodiments, multilayered power consumption control measures may be implemented in a distributed manner at each of a plurality of system layers. In this regard, more effective and sweeping power consumption control measures may be implemented that are tailored based on context at each of a plurality of system layers. Further, some example embodiments may leverage fused context data, which may provide a more robust indication of device and/or user context.

In a first example embodiment, a method is provided, which comprises accessing fused context data. The method of this example embodiment further comprises determining at least one power consumption control measure for each of a plurality of system layers based at least in part on the fused context data. The method of this example embodiment additionally comprises performing multilayered power consumption control by implementing at each respective system layer of the plurality of system layers the at least one power consumption control measure determined for the respective system layer.

In another example embodiment, an apparatus is provided. The apparatus of this example embodiment comprises at least one processor and at least one memory storing computer program code, wherein the at least one memory and stored computer program code are configured, with the at least one processor, to cause the apparatus to at least access fused context data. The at least one memory and stored computer program code are configured, with the at least one processor, to further cause the apparatus of this example embodiment to determine at least one power consumption control measure for each of a plurality of system layers based at least in part on the fused context data. The at least one memory and stored computer program code are configured, with the at least one processor, to additionally cause the apparatus of this example embodiment to perform multilayered power consumption control by implementing at each respective system layer of the plurality of system layers the at least one power consumption control measure determined for the respective system layer.

In another example embodiment, a computer program product is provided. The computer program product of this example embodiment includes at least one computer-readable storage medium having computer-readable program instructions stored therein. The program instructions of this example embodiment comprise program instructions configured to access fused context data. The program instructions of this example embodiment further comprise program instructions configured to determine at least one power consumption control measure for each of a plurality of system layers based at least in part on the fused context data. The program instructions of this example embodiment additionally comprise program instructions configured to perform multilayered power consumption control by implementing at each respective system layer of the plurality of system layers the at least one power consumption control measure determined for the respective system layer.

In another example embodiment, an apparatus is provided that comprises means for accessing fused context data. The apparatus of this example embodiment further comprises means for determining at least one power consumption control measure for each of a plurality of system layers based at least in part on the fused context data. The apparatus of this example embodiment additionally comprises means for performing multilayered power consumption control by implementing at each respective system layer of the plurality of system layers the at least one power consumption control measure determined for the respective system layer.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described various embodiments in general terms, reference will now be made to the accompanying drawings, which are not necessarily drawn to scale, and wherein:

FIG. 1 illustrates a block diagram of a context-aware apparatus for providing context-based power consumption control according to an example embodiment;

FIG. 2 is a schematic block diagram of a mobile terminal according to an example embodiment;

FIG. 3 illustrates a conceptual block diagram of the distributed sensing process provided by an example embodiment;

FIG. 4 illustrates an implementation architecture for providing context sensing and fusion according to an example embodiment;

FIG. 5 illustrates an alternative implementation architecture for providing context sensing and fusion according to an example embodiment;

FIG. 6 illustrates a conceptual block diagram of multilayered power consumption control provided by an example embodiment; and

FIG. 7 is a flowchart according to another example method for providing context-based power consumption control according to an example embodiment.

### DETAILED DESCRIPTION

Some embodiments will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention. As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Further, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

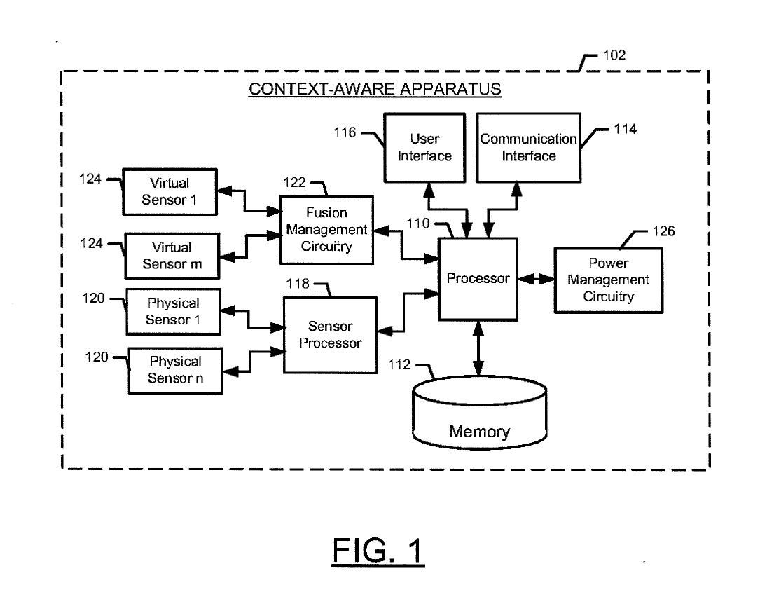

FIG. 1 illustrates a block diagram of a context-aware apparatus 102 for providing context-based power consumption control according to an example embodiment. It will be appreciated that the context-aware apparatus 102 is provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a context-aware apparatus for providing context-based power consumption control, other configurations may also be used to implement embodiments of the present invention.

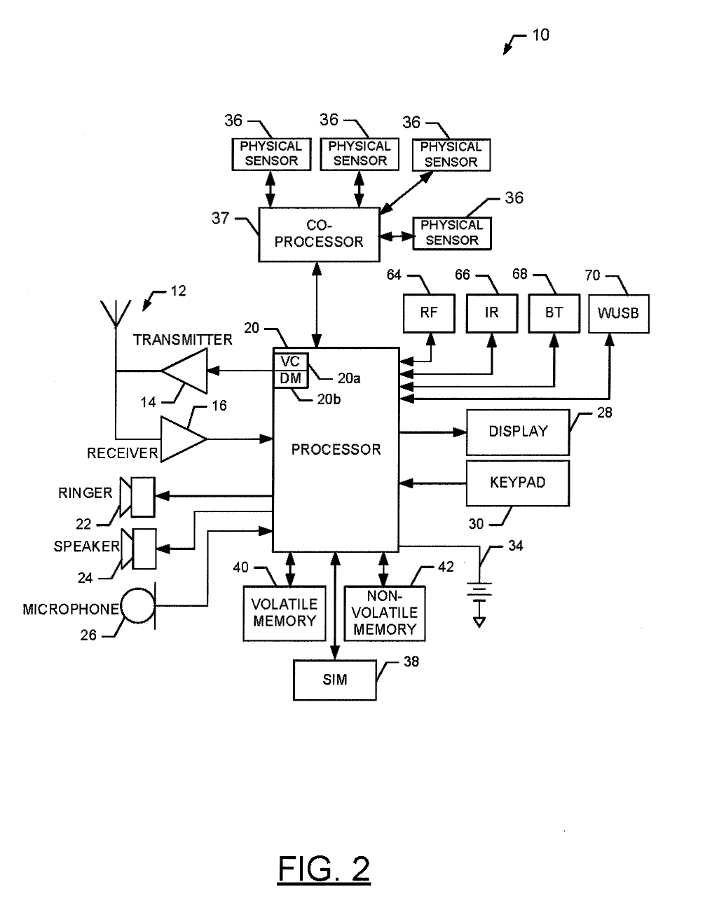

The context-aware apparatus 102 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, any combination thereof, and/or the like. In an example embodiment, the context-aware apparatus 102 is embodied as a mobile terminal, such as that illustrated in FIG. 2.

In this regard, FIG. 2 illustrates a block diagram of a mobile terminal 10 representative of one embodiment of a context-aware apparatus 102. It should be understood, however, that the mobile terminal 10 illustrated and hereinafter described is merely illustrative of one type of context-aware apparatus 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery 34 for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity, WLAN techniques such as IEEE 802.11 techniques, IEEE 802.15 techniques, IEEE 802.16 techniques, and/or the like.

In addition, the mobile terminal 10 may include one or more physical sensors 36. The physical sensors 36 may be devices capable of sensing or determining specific physical parameters descriptive of the current context of the mobile terminal 10. For example, in some cases, the physical sensors 36 may include respective different sensing devices for determining mobile terminal environmental-related parameters such as speed, acceleration, heading, orientation, inertial position relative to a starting point, location, proximity to other devices or objects, lighting conditions and/or the like.

In an example embodiment, the mobile terminal 10 may further include a co-processor 37. The co-processor 37 may be configured to work with the processor 20 to handle certain processing tasks for the mobile terminal 10. In an example embodiment, the co-processor 37 may be specifically tasked with handling (or assisting with) context extraction and fusion capabilities for the mobile terminal 10 in order to, for example, interface with or otherwise control the physical sensors 36 and/or to manage the extraction and fusion of context information.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the context-aware apparatus 102 includes various means for performing the various functions herein described. These means may comprise one or more of a processor 110, memory 112, communication interface 114, user interface 116, sensor processor 118, fusion management circuitry 122, or power management circuitry 126. The means of the context-aware apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the context-aware apparatus 102 as described herein. The plurality of processors may be embodied on a single computing device or distributed across a plurality of computing devices collectively configured to function as the context-aware apparatus 102. In embodiments wherein the context-aware apparatus 102 is embodied as a mobile terminal 10, the processor 110 may be embodied as or comprise the processor 20. In an example embodiment, the processor 110 is configured to execute instructions stored in the memory 112 or otherwise accessible to the processor 110. These instructions, when executed by the processor 110, may cause the context-aware apparatus 102 to perform one or more of the functionalities of the context-aware apparatus 102 as described herein. As such, whether configured by hardware or software methods, or by a combination thereof, the processor 110 may comprise an entity capable of performing operations according to various embodiments while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. Although illustrated in FIG. 1 as a single memory, the memory 112 may comprise a plurality of memories. The plurality of memories may be embodied on a single computing device or may be distributed across a plurality of computing devices collectively configured to function as the context-aware apparatus 102. In various example embodiments, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the context-aware apparatus 102 is embodied as a mobile terminal 10, the memory 112 may comprise the volatile memory 40 and/or the non-volatile memory 42. The memory 112 may be configured to store information, data, applications, instructions, or the like for enabling the context-aware apparatus 102 to carry out various functions in accordance with various example embodiments. For example, in some example embodiments, the memory 112 is configured to buffer input data for processing by the processor 110. Additionally or alternatively, in some example embodiments, the memory 112 is configured to store program instructions for execution by the processor 110. The memory 112 may store information in the form of static and/or dynamic information. The stored information may include, for example, context data obtained from one or more physical sensors 120 and/or from one or more virtual sensors 124. As another example, the stored information may include fused context data, such as may have been fused by the fusion management circuitry 122. This stored information may be stored and/or used by the sensor processor 118, fusion management circuitry 122, and/or power management circuitry 126 during the course of performing their functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In an example embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications with a remote computing device. In this regard, the communication interface 114 may be configured to receive and/or transmit data using any protocol that may be used for transmission of data over a wireless network, wireline network, some combination thereof, or the like by which the context-aware apparatus 102 and one or more computing devices may be in communication. The communication interface 114 may additionally be in communication with the memory 112, user interface 116, sensor processor 118, fusion management circuitry 122, and/or power management circuitry 126, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may further be in communication with the memory 112, communication interface 114, sensor processor 118, fusion management circuitry 122, and/or power management circuitry 126, such as via a bus.

Although not included in all embodiments, in some example embodiments the context-aware apparatus may further include a sensor processor 118. The sensor processor 118 may have similar structure (albeit perhaps with semantic and scale differences) to that of the processor 110 and may have similar capabilities thereto. However, according to some example embodiments, the sensor processor 118 may be configured to interface with one or more physical sensors 120 (for example, physical sensor 1, physical sensor 2, physical sensor 3, . . . , physical sensor n, where n is an integer equal to the number of physical sensors) such as, for example, an accelerometer, a magnetometer, a proximity sensor, an ambient light sensor, a positioning sensor, and/or any of a number of other possible sensors. In some embodiments, the sensor processor 118 may access a portion of the memory 112 or some other memory to execute instructions stored thereat. Accordingly, for example, the sensor processor 118 may be configured to interface with the physical sensors 120 via sensor specific firmware that is configured to enable the sensor processor 118 to communicate with respective physical sensors 120. In some embodiments, the sensor processor 118 may be configured to extract information from the physical sensors 120 (perhaps storing such information in a buffer in some cases), perform sensor control and management functions for the physical sensors 120 and perform sensor data pre-processing. In an example embodiment, the sensor processor 118 may also be configured to perform sensor data fusion with respect to the physical sensor data extracted. The fused physical sensor data may be communicated to the processor 110 and/or to the fusion management circuitry 122 (which is described in greater detail below) for further processing. In some embodiments, the sensor processor 118 may include a host interface function for managing the interface between the processor 110 and the sensor processor 118 at the sensor processor 118 end. As such, the sensor processor 118 may be enabled to provide data from the physical sensors 120, status information regarding the physical sensors 120, control information, queries and context information to the processor 110 and/or to the fusion management circuitry 122. In embodiments wherein the context-aware apparatus 102 does not include a sensor processor 118, the physical sensors 120 may be interfaced with the processor 110 and/or fusion management circuitry 122 and the processor 110, fusion management circuitry 122, or some combination thereof may be configured to perform functionality attributed to the sensor processor 118 in the foregoing description.

The fusion management circuitry 122 may be embodied as various means, such as circuitry, hardware, a computer program product comprising computer readable program instructions stored on a computer readable medium (e.g., the memory 112) and executed by a processing device (e.g., the processor 110), some combination thereof, or the like. In some embodiments, the fusion management circuitry 122 is embodied as or otherwise controlled by the processor 110. In embodiments wherein the fusion management circuitry 122 is embodied separately from the processor 110, the fusion management circuitry 122 may be in communication with the processor 110. The fusion management circuitry 122 may further be in communication with one or more of the memory 112, communication interface 114, user interface 116, sensor processor 118, or power management circuitry 126, such as via a bus.

In some embodiments, the fusion management circuitry 122 may be configured to communicate with the sensor processor 118 (e.g., in some embodiments that employ the sensor processor 118) to receive pre-processed physical sensor data and/or fused physical sensor data. In embodiments where no sensor processor 118 is employed, the fusion management circuitry 122 may be further configured to pre-process and/or fuse physical sensor data. In some example embodiments, the fusion management circuitry 122 may be configured to interface with one or more virtual sensors 124 (for example, virtual sensor 1, virtual sensor 2, . . . , virtual sensor m, where m is an integer equal to the number of virtual sensors) in order to fuse virtual sensor data with physical sensor data. Virtual sensors 124 may include sensors that do not measure physical parameters. Thus, for example, virtual sensors 124 may monitor such virtual parameters as RF (radio frequency) activity, time, calendar events, device state information, active profiles, alarms, battery state, application data, data from webservices, certain location information that is measured based on timing (for example, global positioning system (GPS) position) or other non-physical parameters (for example, cell-ID), and/or the like. The virtual sensors 124 may be embodied as hardware or as combinations of hardware and software configured to determine the corresponding non-physical parametric data associated with each respective virtual sensor.

The power management circuitry 126 may be embodied as various means, such as circuitry, hardware, a computer program product comprising computer readable program instructions stored on a computer readable medium (e.g., the memory 112) and executed by a processing device (e.g., the processor 110), some combination thereof, or the like. In some embodiments, the power management circuitry 126 is embodied as or otherwise controlled by the processor 110. In embodiments wherein the power management circuitry 126 is embodied separately from the processor 110, the power management circuitry 126 may be in communication with the processor 110. The power management circuitry 126 may further be in communication with one or more of the memory 112, communication interface 114, user interface 116, sensor processor 118, or fusion management circuitry 122, such as via a bus.

As will be described further herein below, the power management circuitry 126 may be configured to access context data. The accessed context data may, for example, comprise fused context data. The accessed context data may indicate a context of the context-aware apparatus 102 a context of an environment of the context-aware apparatus 102, and/or a context of a user thereof. In this regard, the context data may be derived from the output of one or more physical sensors 120 and/or from the output of one or more virtual sensors 124. The power management circuitry 126 may use the accessed context data to determine one or more power consumption control measures. It will be appreciated that in embodiments wherein the power management circuitry 126 is configured to access and use fused context data, the fused context data may be formed using any appropriate context fusion technique. Accordingly, the fused context data may be formed through context fusion performed by the sensor processor 118, fusion management circuitry 122, processor 110, or a combination thereof.

In some example embodiments, the fusion management circuitry 122 may be configured to access fused context data formed through a distributed context fusion performed at each of a plurality of system layers. In this regard, for example, context information may be determined (or sensed) based on inputs from one or more physical sensors 120 and one or more virtual sensors 124. After extraction of sensor data (which may define or imply context information) from the physical and/or virtual sensors, fusion may be accomplished homogeneously (for example, fusion contexts derived from physical sensors and operating system virtual sensors and the output is a fused context) or heterogeneously (for example, inputs are a combination of context information from lower layers and virtual sensor data). As such, the data that is fused at any particular operating system layer according to example embodiments may be either sensor data (physical and/or virtual) being fused with other sensor data, or sensor data being fused with context information from lower layers (which may itself include sensor data fused with other sensor data and/or context information from lower layers).

In some embodiments, the fusion of virtual sensor data with physical sensor data may be classified into different levels. For example, context fusion may occur at the feature level, which may be accomplished at a base layer, at a decision level, which may correspond to middleware, or in independent applications, which may correspond to an application layer. Accordingly, the fusion management circuitry 122 may be configured to manage context fusion (for example, the fusion of virtual and physical sensor data related to context information) at various ones and combinations of the levels described above.

Thus, according to some example embodiments, context data extraction and fusion of the context data that has been extracted may be performed by different entities, processors or processes in a distributed fashion or layered/linear way. The sensor processor 118 may, for example, pre-process physical sensor data obtained from one or more physical sensors 120 and extract a first level of context data. In some embodiments, the sensor processor 118 may perform data level context fusion on the physical sensor data. The sensor processor 118 may be configured to use pre-processed data and context from other subsystems that may have some type of physical data source (for example, modem, RF module, audio/video module, GPS subsystems, etc.) and perform a context fusion. In some embodiments, the fusion management circuitry 122 may perform a second level, and perhaps also subsequent levels, of context fusion to fuse the physical sensor data with virtual sensor data. As such, the fusion management circuitry 122 may fuse virtual sensor data and physical sensor data in the operating system layers of the apparatus.

In embodiments wherein the processor 110 runs an operating system, the fusion management circuitry 122 may have access to the context and physical sensor data from the sensor processor 118. The fusion management circuitry 122 may also have access to other subsystems with physical data sources and the virtual sensors. Thus, a layered or distributed context sensing process may be implemented. In this regard, the fusion management circuitry 122, sensor processor 118, or some combination thereof may be configured to form fused context data using any of the various distributed context fusion techniques described in International Patent Application Number PCT/IB2010/001109, filed on May 13, 2010, the contents of which are incorporated herein by reference.

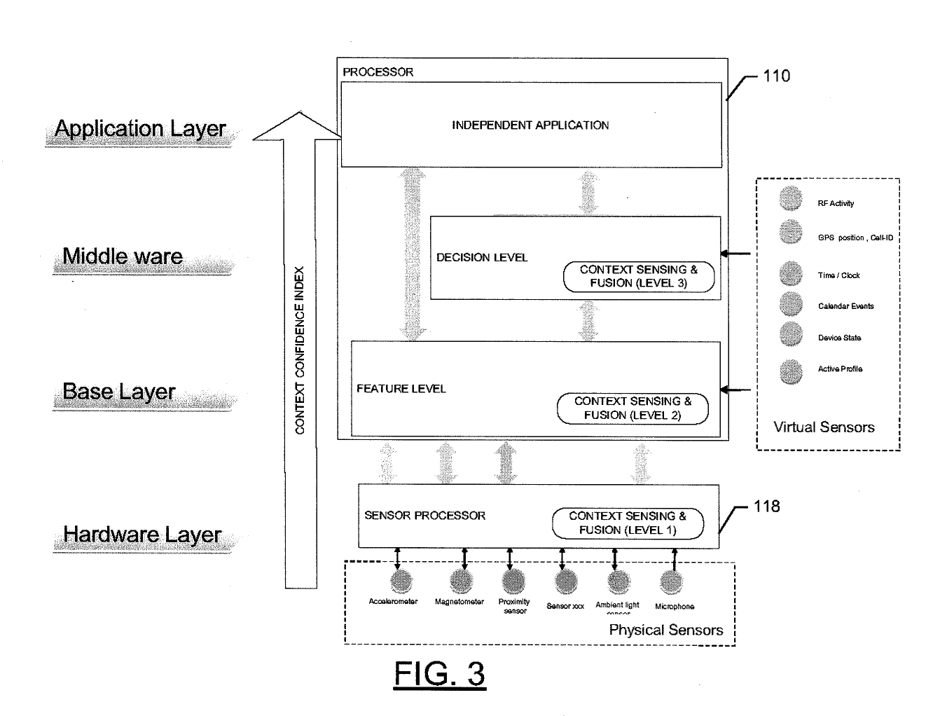

As an example, FIG. 3 illustrates a conceptual block diagram of the distributed sensing process implemented in some example embodiments. As shown in FIG. 3, each context fusion process running in different layers of the operating system of the processor 110 may add more information to the context and increases a context confidence index. Accordingly, by increasing the context confidence index, more reliable context information may ultimately be generated for use in connection with providing services to the user. In this regard, for example, the sensor processor 118 may perform context sensing and fusion on the physical sensor data received thereat in a first level of context fusion at the hardware layer. A second level of context fusion may take place at the processor 110 (for example, via the fusion management circuitry 122) by fusing the physical sensor data with some virtual sensor data at the feature level corresponding to the base layer. A third level of context fusion may take place at the processor 110 by fusing the context data fused at the feature level with additional virtual sensor data. The third level of context fusion may occur at the decision level corresponding to the middleware layer and add to the context confidence index. Accordingly, when the context information is provided to an independent application at the application layer, a higher confidence may be placed in the context data used by the independent application. It should be appreciated that the example of FIG. 3 can be scaled to any number of operating system layers. Thus, in some example embodiments, context fusion processes may be run in any of the layers of an operating system such that the number of context fusion processes is not limited to three as shown in FIG. 3.

It should also be appreciated that the independent application may perform yet another (for example, a fourth level) of context sensing and fusion at the application layer. Moreover, as is shown in FIG. 3, the independent application may have access to both level 2 and level 3 context information. Thus, the independent application may be enabled to perform context fusion involving context information from multiple preceding levels or even selectively incorporate context information from specific desired ones of the preceding levels in some embodiments.

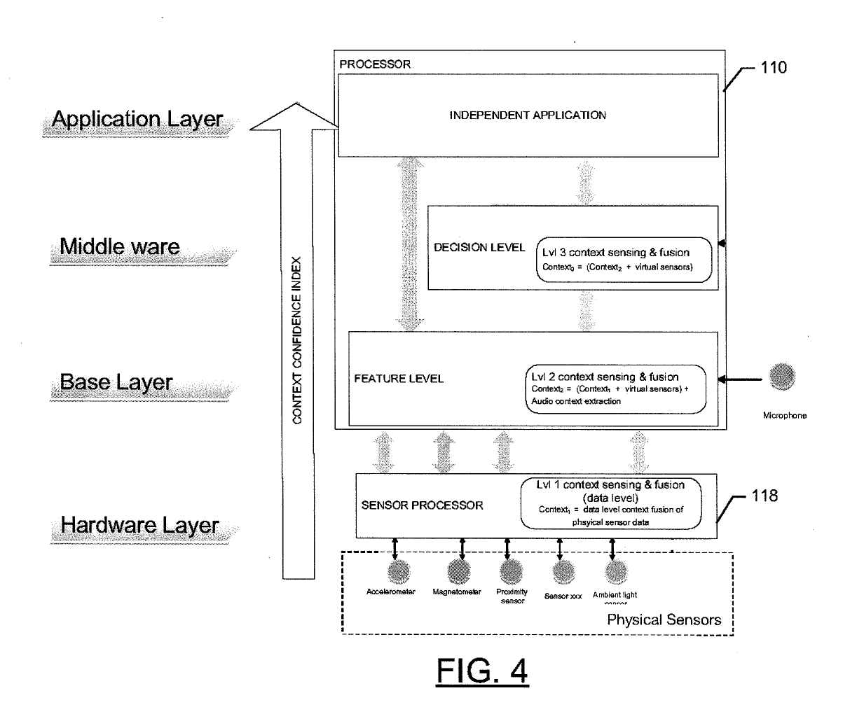

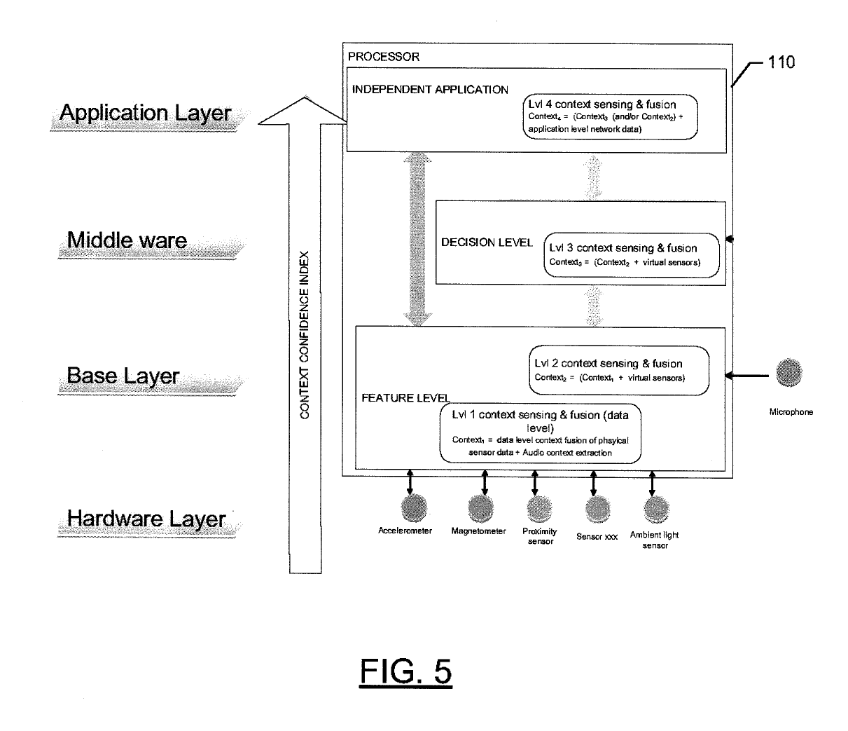

FIGS. 4 and 5 illustrate different implementation architectures according to various different and non-limiting examples. As such, it should be appreciated that the implementation architecture employed may be different in respective different example embodiments. For example, instead of audio data being interfaced into the sensor processor 118 (shown in FIG. 3 by virtue of the microphone being provided as an input to the sensor processor 118), the audio data could instead be interfaced directly to the processor 110 as is shown in FIG. 4. In this regard, in FIG. 3, several physical sensors (an accelerometer, magnetometer, proximity sensor, and ambient light sensor) are interfaced to the sensor processor 118 and a microphone is interfaced to the processor 110. Level 1 or data level context extraction and fusion may then be performed in the sensor processor 118 and the context data that results may be communicated to the processor 110 (for example, when requested or when a change of event occurs). Data corresponding to Context₁ may therefore be defined as a set of fused context data derived from a set of context data sensed by the physical sensors. Level 2 context fusion may then occur in the base layer (for example, feature level fusion) which may involve the basic context generated during level 1 context fusion, audio context extracted from the microphone interfaced with the processor 110, and virtual sensor data from one or more virtual sensors to create more reliable context information with a time stamp. As such, Context₂ may be formed from the fusion of Context₁ with virtual sensor data or contexts fused with context information from the audio based context sensing. The fusion management circuitry 122 may perform level 3 context fusion at the middleware layer with additional virtual sensor data that may be different than the virtual sensor data involved in context fusion used in the base layer for level 2 context fusion. As such, Context₃ may be formed from the fusion of Context₂ with virtual sensor data or context information. Thus, FIG. 3 differs from FIG. 4 in that the example embodiment of FIG. 4 performs audio based context extraction via the processor 110, while the example embodiment of FIG. 3 performs audio based context extraction via the sensor processor 118. As such, fusion of audio context data may occur at the base layer rather than in the hardware layer (as is the case in FIG. 3). It will be appreciated, however, that the microphone is used as an example of potential arrangements for interfacing a physical sensor. Accordingly, any physical sensor may be interfaced with the sensor processor 118 or with the processor 110 in accordance with example embodiments.

FIG. 5 illustrates another example embodiment in which the sensor processor 118 is excluded. In the embodiment of FIG. 5, all of the sensors (virtual and physical) are interfaced to the processor 110 and level 1 fusion may be performed at a data level by the processor 110, and may include fusion with the audio context data. Thus, data corresponding to Context₁ may therefore be defined as a set of fused context data derived from a set of context data sensed by the physical sensors, fused also with the audio context data. Level 2 context extraction and fusion may be performed in the operating system base layer to fuse the level 1 context data (e.g., Context₁) with virtual sensor data to provide level 2 context data (e.g., Context₂). The level 3 context processes may be run by the fusion management circuitry 122 in middleware to produce level 3 context data (e.g., Context₃) based on a fusion of the level 2 context data with additional virtual sensor data. As described above, in some cases, the fusion management circuitry 122 may perform a fourth level of context fusion in the application layer since the independent application may have access to both level 2 and level 3 context information. Moreover, the independent application could also be in communication with a network (or a web service or some other network device) to perform application level context fusion.

Accordingly, the power management circuitry 126 may be configured to access fused context data having been formed by any appropriate context fusion process or plurality of context fusion processes performed in combination. In some embodiments, the power management circuitry 126 may be configured to access fused context data having been formed at a highest layer at which context fusion was performed. As another example, the power management circuitry 126 may be configured to access fused context data having been formed at a highest layer at which the power management circuitry 126 is performing power consumption control. Thus, for example, if the highest layer at which context fusion has been performed is the application layer or if the highest layer at which the power management circuitry 126 is performing power consumption control is the application layer, the power management circuitry 126 may access fused context data having been formed at the application layer. In this regard, as discussed with respect to FIGS. 3-5, context data fused at each progressively higher layer may increase a context confidence index by providing more robust data from which a context may be more accurately derived. In such embodiments wherein the power management circuitry 126 accesses fused context data having been formed at a highest layer at which context fusion was performed and/or wherein the power management circuitry 126 accesses fused context data having been formed at a highest layer at which the power management circuitry 126 is performing power consumption control, the power management circuitry 126 may be configured to use the fused context data as the basis for determining power consumption control measures for each of a plurality of system layers.

In other embodiments, the power management circuitry 126 may be configured to access fused context data formed at each of a plurality of layers. For example, if the power management circuitry 126 is performing power consumption control at three different layers, the power management circuitry 126 may be configured to access fused context data formed through a context fusion process performed at each of the three layers. Accordingly, when determining a power consumption control measure(s) for a respective system layer of the three system layers, the power management circuitry 126 may be configured to use fused context data having been accessed from the respective layer as a basis for determining the power consumption control measure(s).

In order to facilitate determination of a power consumption control measure, the power management circuitry 126 may be configured to determine one or more contexts indicated by accessed fused context data. In this regard, the fused context data may indicate one or more of a context(s) of the context-aware apparatus 102, a context(s) of an environment of the context-aware apparatus 102, or a context(s) of a user of the context-aware apparatus 102. Accordingly, contexts may be categorized into classes. A context of the context-aware apparatus 102 may be categorized under the “terminal” class and may indicate a spatio-temporal condition of the context-aware apparatus 102. Accordingly, a context of the context-aware apparatus 102 may provide physical information on a state of the context-aware apparatus 102 in its environment. A context of an environment of the context-aware apparatus 102 may be categorized under the “environment” class and may provide information on a state of an environment in which the context-aware apparatus 102 is in operation. A context of a user of the context-aware apparatus 102 may be categorized under the “user activity” class and may provide information on user activity of a user of the context-aware apparatus 102.

As an example, contexts categorized in the terminal context class (e.g., contexts of the context-aware apparatus 10), which may be indicated by the accessed fused context data may include the following:

| | |
|---|---|
| Context Class | Context |

| | | |
|---|---|---|
| Terminal Context | Orientation | Face up |
| | | Face down |
| | | Landscape |
| | | Portrait |
| | Location | Desk |
| | | Pocket |
| | | Mounted |
| | State | Idle |
| | | Active |
| | Undetermined: Default | |

As a further example, contexts categorized in the environment context class (e.g., contexts of the context-aware apparatus 10), which may be indicated by the accessed fused context data may include the following:

| Context Class | Context | |
|---|---|---|
| Environment | Indoor | Quiet |
| | | Conversation |
| | | Public |
| | | Noisy |
| | Outdoor | Quiet |
| | | Public |
| | | Traffic |
| | Commute | Car |
| | | Mass Commute: Train, Bus |
| | Undetermined: Default | |

As still a further example, contexts categorized in the user activity context class (e.g., contexts of a user of the context-aware apparatus 10), which may be indicated by the accessed fused context data may include the following:

| | |
|---|---|
| Context Class | Context |

| | | |
|---|---|---|
| User Activity | Still | Idle |
| | | Sit |
| | | Stand |
| | Active | Walk |
| | | Run |
| | | Cycle |
| | Commute | Car |
| | | Cycle |
| | | Mass Commute: |
| | | Train, Bus |
| | Undetermined: Default | |

The power management circuitry 126 may accordingly be configured to determine a power consumption control measure based at least in part on the context(s) indicated by accessed fused context data. In this regard, the power management circuitry 126 may be configured to determine a power consumption control measure that is appropriate given a current context indicated by the fused context data. Accordingly, as an example, the power management circuitry 126 may be configured to determine a power consumption control measure having a predefined association with a context indicated by accessed fused context data.

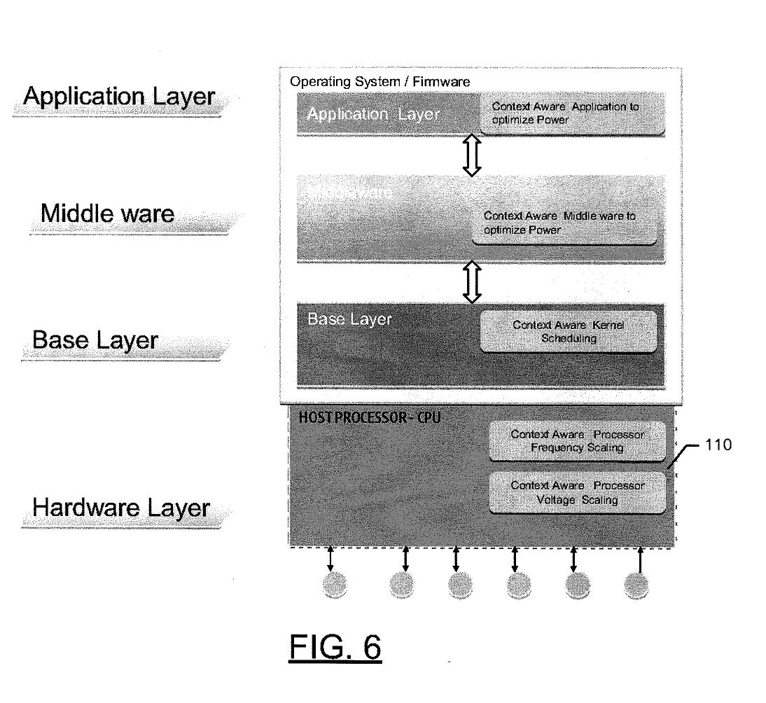

It will be appreciated that the power management circuitry 126 may be configured to leverage fused context data to determine one or more power consumption control measures for each of a plurality of system layers, thereby enabling distributed power consumption control. The plurality of system layers for which power consumption control measures are determined may comprise a subset of the set of system layers implemented on the context-aware apparatus 102 or other apparatus on which an embodiment is implemented. Referring now to FIG. 6, FIG. 6 illustrates a conceptual block diagram of multilayered power consumption control provided by an example embodiment. As may be seen, in the example embodiment illustrated in FIG. 6, the power management circuitry 126 may be configured to determine and implement power consumption control measures at a hardware layer and one or more operating system layers. The operating system layers may, for example, comprise a base layer, middleware layer, and/or application layer. However, it will be appreciated that the operating system may be comprised of additional or alternative layers in other embodiments. Further, it will be appreciated that in some example embodiments, the hardware layer may be divided into sub-layers. Additionally, while FIG. 6 illustrates the implementation of power consumption control measures at each system layer illustrated in FIG. 6, it will be appreciated that in some example embodiments, power consumption control measures may be implemented at a subset comprising two or more of the illustrated system layers.

The hardware layer may comprise one or more hardware elements, such as the processor 110, sensor processor 118, physical sensors 120, and/or the like. Accordingly, the power management circuitry 126 may be configured to determine one or more power consumption control measures for the hardware layer that may control power consumption by one or more hardware elements. As an example, the hardware layer may be configured to determine to scale a clock frequency and/or a supply voltage for a processor (e.g., the processor 110 and/or sensor processor 118) as a power consumption control measure. For example, if the context-aware apparatus 102 is idle and/or if some other context is determined that indicates that processor performance may be reduced so as to conserve power, the power management circuitry 126 may be configured to reduce a clock frequency and/or a supply voltage for a processor. In this regard, the power management circuitry 126 may be configured to provide and/or control operation of a processor control module.

For example, the power management circuitry 126 may be configured to control operation of a processor control module configured to scale clock frequency, which may be defined as follows:

int cpufreq_driver_target(struct cpufreq_policy *policy,

unsigned int target_freq,
unsigned int relation);

The processor control module may be conditionally invoked based on determined context. For example, the processor control module may be conditionally invoked as follows:

if (context.environment.indoor.quiet==true && context.useractivity.still.idle==true &&
context.terminal.desk==true)

| | |
|---|---|
| cpufreq_driver_target( on_demand, 50Mhz, 1); | //probably user is not using the |

```
  context-aware apparatus 102 and
  it is night, so processor can run at
  lowest frequency
```

In this example, the scaling frequency 50 MHz may be between the governor policy->Scaling_min_freq and policy->Scaling_max_freq. Accordingly, the power management circuitry 126 may provide a context-aware processor frequency control and may use different processor governor policies, or use On_demand with relatively conservative minimum/maximum frequency levels and switch between them based on context. Alternatively, the power management circuitry 126 may provide a context-aware processor frequency control implementing more aggressive frequency scaling.

The base layer or other layer of the operating system may comprise a kernel. The power management circuitry 126 may be configured to determine and implement power consumption control measures in a layer comprising a kernel that may control operation of the kernel. In this regard, the power management circuitry 126 may be configured to implement a context aware kernel scheduling policy that may optimize the kernel's task list depending on the current context and an estimated future context (e.g., a context predicted on historical usage patterns, available user scheduling information, and/or the like).

As an example, the power management circuitry 126 may adjust kernel task scheduling such that lesser tasks (e.g., system tasks-level 0) may be deferred while the context-aware apparatus 102 is idle as determined based on context information. For example, the power management circuitry 126 may allow high priority system tasks to be performed during the idle period, but may defer application tasks and low level tasks (e.g., syncing, application updates, repository refresh, device software updates and update checks, and/or the like). The power management circuitry 126 may maintain a list of deferred tasks so that they may be scheduled when the scheduling policy is restored to a default state responsive to a change in context. In this regard, for example, the power management circuitry 126 may restore the scheduling policy to a default state in response to a determination that the context-aware apparatus 102 is again active based on an updated context. Accordingly, the power management circuitry 126 may be configured to detect that the context-aware apparatus 102 is idle and adjust the kernel scheduling to defer lesser tasks that would otherwise be performed during the idle period, thus allowing more sleep time and possibly conserving power.

For example, the power management circuitry 126 may enable a context-based scheduling policy in response to a determination that it is night and the context-aware apparatus 102 is idle. For example, the power management circuitry 126 may conditionally invoke a context-based scheduling policy as follows:

if (context.environment.indoor.quite==true &&
context.useractivity.still.idle==true && context.terminal.desk==true)

enable_context_scheduleing( );

In an example embodiment, an alarm event, or a pre-alarm event, such as may be associated with a user-configured alarm to awaken the user from a state of sleep or notify the user of the start of an event may trigger the power management circuitry 126 to restore a default scheduling policy. In this regard, restoring the default scheduling policy may enable the context-aware apparatus 102 to proactively prepare itself for active operation by scheduling tasks deferred while the context-aware scheduling policy was implemented.

As another example, the power management circuitry 126 may be configured to restore a default scheduling policy responsive to a change in user and/or device context (e.g., the user has picked up, touched, and/or provided input to the context-aware apparatus 102). As yet another example, rather than automatically restoring a default scheduling policy, a user may be prompted to select whether the user wishes to restore normal operation. For example, the user may be prompted: “There are N deferred tasks. Would you like to run the deferred tasks now?” or “I was resting and saving energy. Would you like to run a refresh now?”

The power management circuitry 126 may be configured to determine and implement a variety of power consumption control measures at the middleware and application levels. Such power consumption control measures may directly control operation of applications or may, for example, control operation of hardware resources (e.g., backlights, speakers, display, radio receivers/transmitters, and/or the like that may be used by an application). Thus, for example, the power management circuitry 126 may adjust an intensity of a backlight or display responsive to a change in context. As another example, the power management circuitry 126 may be configured to adjust a volume of a speaker output responsive to a change in context. As a further example, the power management circuitry 126 may be configured to activate/deactivate a receiver and/or transmitter responsive to a change in context. As another example, the power management circuitry 126 may selectively control which applications are run at the application layer responsive to a change in context.

Accordingly, it will be appreciated that the power management circuitry 126 may leverage fused context information, such as may have been formed using a distributed context fusion process, to determine and implement multilayered power consumption control. In this regard, the power management circuitry 126 may determine and implement power consumption control measures for a plurality of system layers.

The following is a table showing a context and associated power consumption control measures in accordance with one example embodiment. In this regard, the power management circuitry 126 may be configured to determine based on accessed context information whether a charger is connected to the context-aware apparatus 102 and, if a charger is not connected, an amount of power remaining in a battery that may be powering the context-aware apparatus 102. The power management circuitry 126 may accordingly, implement progressively more aggressive power consumption control measures if a charger is not connected as the power drops.

| Charger connected | | All application and services can run |
|---|---|---|
| | | as normal and there will not be a |
| | | need for context aware power |
| | | consumption control |
| Charger Not | Battery = 100% | Context aware power consumption |
| connected | | control can be used |
| | | Priority based scheduling |
| | Battery = 50% | Context aware application power |
| | | consumption control should be used |
| | | aggressively |
| | | Priority based scheduling |
| | | Context aware CPU freq and voltage |
| | | scaling |
| | | Email, calendar voice call will work |
| | | as normal |
| | Battery = <10% | No applications and widgets are |
| | | active. Only voice call and |
| | | emergency call are active |

In another example embodiment, the power management circuitry 126 may be configured to implement the following multilayered power consumption control measures responsive to determination of the respective corresponding contexts:

| | | Device | |
|---|---|---|---|
| User activity | Context | State | Optimization |
| Sleep/Rest | Idle | Idle | Kernel Task scheduling rate: |
| | Indoor | | Lowest |
| | Dark | | Number of kernel Tasks: Lowest |
| | | | No widget and service updates |
| | | | Other device peripherals in sleep |
| | | | mode |
| | | | RF power consumption control |
| | | | Host waits for a specific time/ |
| | | | alarm for wake up or |
| | | | context.Terminal. active is true |
| Commute | Idle | Standby | Kernel Task scheduling rate: |
| Free time | Indoor | Semi- | Medium |
| | Pocket | Active | Number of kernel Tasks: Medium |
| | | | Low activity on widget and |
| | | | service updates |
| | | | Host waits for context.Terminal. |
| | | | active is true |
| Work | Office | Active | Kernel Task scheduling rate: |
| | Meeting | | Normal |
| | Activity | | Number of kernel Tasks: normal |
| | | | Normal activity on widget and |
| | | | service updates |
| | | | Host waits for Terminal idle |
| | | | context to go back to device |
| | | | standby mode. |

As a further example, the power management circuitry 126 may be configured to implement the following multilayered power consumption control measures responsive to determination of the respective corresponding contexts:

| Context1 | Context2 | Optimization |
|---|---|---|
| Indoor | Dark, Night, Home | Display back light: Lowest |
| | | Vibra Lowest |
| | | RF Usage: Low |
| | | Keypad illumination: medium |
| | Office | Display back light: Low/medium |
| | | Vibra: Normal |
| | | RF Usage: Normal |
| | | Keypad illumination: Off |
| Outdoor | Direct Sun | Display back light: High |
| | | Vibra: Normal |
| | | RF Usage: Normal |
| | | Keypad illumination: Off |
| | Public, | Display back light: Medium |
| | Reverberant | Vibra: High |
| | | RF Usage: Normal |
| | | Keypad illumination: medium |

In some example embodiments, when the power management circuitry 126 implements a power consumption control measure, the power management circuitry 126 may implement the power consumption control measure incrementally. In this regard, in an instance in which a user is still using the context-aware apparatus 102, an abrupt implementation of a power consumption control measure may negatively impact user experience. However, if a power consumption control measure is implemented incrementally, adjustments made in accordance with the optimization measure may be made gradually and thus may be less perceptible to the user.

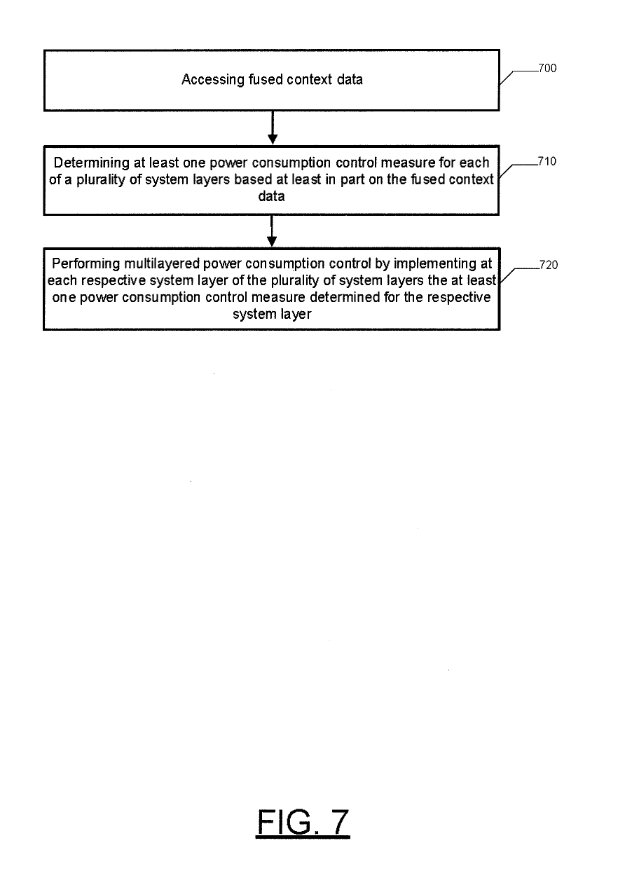

FIG. 7 is a flowchart according to another example method for providing context-based power consumption control according to an example embodiment. The operations illustrated in and described with respect to FIG. 7 may, for example, be performed by, with the assistance of, and/or under the control of one or more of the processor 110, memory 112, communication interface 114, user interface 116, sensor processor 118, fusion management circuitry 122, or power management circuitry 126. In this regard, means, such as the power management circuitry 126 and/or processor 110, may be provided access to fused context data, as shown in operation 700. The apparatus may also include means, such as the power management circuitry 126 and/or processor 110, for determining at least one power consumption control measure for each of a plurality of system layers based at least in part on the fused context data. See operation 710. The plurality of system layers for which power consumption control measures are determined may comprise a subset of the set of system layers implemented on the context-aware apparatus 102 or other apparatus on which an embodiment is implemented. Further, the apparatus may include means, such as the power management circuitry 126 and/or processor 110, for performing multilayered power consumption control by implementing at each respective system layer of the plurality of system layers the at least one power consumption control measure determined for the respective system layer. See operation 720.

FIG. 7 is a flowchart of a system, method, and computer program product according to various example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories (e.g., the memory 112) on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., a context-aware apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (e.g., the processor 110) may provide all or a portion of the elements. In another embodiment, all or a portion of the elements may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A method comprising:
accessing fused context data;
determining at least one power consumption control measure for a plurality of system layers based at least in part on the fused context data; and
performing multilayered power consumption control by implementing at respective system layers of the plurality of system layers the at least one power consumption control measure determined for the respective system layer.

2. The method of claim 1, wherein the fused context data comprises context data formed through distributed context fusion performed at multiple system layers.

3. (canceled)

4. The method of claim 1, wherein:
accessing fused context data comprises accessing at respective system layers of the plurality of system layers fused context data having been formed through context fusion at the respective system layer; and
determining at least one power consumption control measure for each of a plurality of system layers comprises, for respective system layers of the plurality of system layers, using the fused context data accessed from the respective system layer to determine at least one power consumption control measure for the respective system layer.

5-6. (canceled)

7. The method of claim 1, wherein implementing a power consumption control measure comprises incrementally implementing the power consumption control measure.

8. The method of claim 1, wherein:
determining at least one power consumption control measure comprises determining for a hardware layer to scale one or more of a clock frequency or a supply voltage for a processor; and
performing multilayered power consumption control comprises scaling the one or more of the clock frequency or the supply voltage for the processor at the hardware layer.

9. The method of claim 1, wherein:
determining at least one power consumption control measure comprises determining for a base layer to adjust kernel scheduling; and
performing multilayered power consumption control comprises adjusting kernel scheduling at the base layer.

10. The method of claim 1, wherein performing multilayered power consumption control comprises implementing, by a processor, at a respective system layer of the plurality of system layers the at least one power consumption control measure determined for the respective system layer.

11-12. (canceled)

13. An apparatus comprising at least one processor and at least one memory storing computer program code, wherein the at least one memory and stored computer program code are configured, with the at least one processor, to cause the apparatus to at least:
access fused context data;
determine at least one power consumption control measure for a plurality of system layers based at least in part on the fused context data; and
perform multilayered power consumption control by implementing at respective system layers of the plurality of system layers the at least one power consumption control measure determined for the respective system layer.

14. The apparatus of claim 13, wherein the fused context data comprises context data formed through distributed context fusion performed at multiple system layers.

15. (canceled)

16. The apparatus of claim 13, wherein the at least one memory and stored computer program code are configured, with the at least one processor, to cause the apparatus to:
access fused context data by accessing at respective system layers of the plurality of system layers fused context data having been formed through context fusion at the respective system layer; and
determine at least one power consumption control measure for a plurality of system layers at least in part by, for respective system layers of the plurality of system layers, using the fused context data accessed from the respective system layer to determine at least one power consumption control measure for the respective system layer.

17-18. (canceled)

19. The apparatus of claim 13, wherein the at least one memory and stored computer program code are configured, with the at least one processor, to cause the apparatus to implement a power consumption control measure by incrementally implementing the power consumption control measure.

20. The apparatus of claim 13, wherein the at least one memory and stored computer program code are configured, with the at least one processor, to cause the apparatus to:
determine at least one power consumption control measure at least in part by determining for a hardware layer to scale one or more of a clock frequency or a supply voltage for a processor; and
perform multilayered power consumption control at least in part by scaling the one or more of the clock frequency or the supply voltage for the processor at the hardware layer.

21. The apparatus of claim 13, wherein the at least one memory and stored computer program code are configured, with the at least one processor, to cause the apparatus to:
determine at least one power consumption control measure at least in part by determining for a base layer to adjust kernel scheduling; and
perform multilayered power consumption control at least in part by adjusting kernel scheduling at the base layer.

22. (canceled)

23. The apparatus of claim 13, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

24. A computer program product comprising at least one computer-readable storage medium having computer-readable program instructions stored therein, the computer-readable program instructions comprising:
program instructions configured to access fused context data;
program instructions configured to determine at least one power consumption control measure for a plurality of system layers based at least in part on the fused context data; and
program instructions configured to perform multilayered power consumption control by implementing at respective system layers of the plurality of system layers the at least one power consumption control measure determined for the respective system layer.

25. The computer program product of claim 24, wherein the fused context data comprises context data formed through distributed context fusion performed at multiple system layers.

26. (canceled)

27. The computer program product of claim 24, wherein:
the program instructions configured to access fused context data comprise program instructions configured to access at respective system layers of the plurality of system layers fused context data having been formed through context fusion at the respective system layer; and
the program instructions configured to determine at least one power consumption control measure for a plurality of system layers comprise, for respective system layers of the plurality of system layers, program instructions configured to use the fused context data accessed from the respective system layer to determine at least one power consumption control measure for the respective system layer.

28-29. (canceled)

30. The computer program product of claim 24, wherein the program instructions configured to perform multilayered power consumption control comprise program instructions configured to incrementally implement a power consumption control measure.

31. The computer program product of claim 24, wherein:
the program instructions configured to determine at least one power consumption control measure comprise program instructions configured to determine for a hardware layer to scale one or more of a clock frequency or a supply voltage for a processor; and
the program instructions configured to perform multilayered power consumption control comprise program instructions configured to scale the one or more of the clock frequency or the supply voltage for the processor at the hardware layer.

32. The computer program product of claim 24, wherein:
the program instructions configured to determine at least one power consumption control measure comprise program instructions configured to determine for a base layer to adjust kernel scheduling; and
the program instructions configured to perform multilayered power consumption control comprise program instructions configured to adjust kernel scheduling at the base layer.

33-44. (canceled)
